(19) United States
(12) Patent Application Publication
(10) Pub. No.: US 2023/0080256 A1
(43) Pub. Date: Mar. 16, 2023

(54) Portable Brewing and Heat Preservation Device

(71) Applicant: Dandelion Studio Ltd., Taipei (TW)

(72) Inventors: Kuan-Yu Lin, Taipei (TW); Heng-Yu Lin, Taipei (TW)

(21) Appl. No.: 17/700,873

(22) Filed: Mar. 22, 2022

(30) Foreign Application Priority Data
Sep. 16, 2021 (TW) 110134662

(51) Int. Cl. A47J 31/00; A47J 31/20; A47J 31/06; A47J 31/44; B01D 39/20; B01D 39/16

(52) U.S. Cl. CPC A47J 31/005; A47J 31/20; A47J 31/06; A47J 31/4407; B01D 39/2068; B01D 39/2003; B01D 39/2027; B01D 39/16; B01D 2239/0478

(57) ABSTRACT

The present invention relates to a portable insulated brewing device, comprising of: a tubular body, wherein a top positioning part and a bottom positioning part are arranged on both sides; an assembly which comprises of a bracket at the top positioning part, wherein the bracket has a plurality of liquid channels, a push-pull rod placed in the accommodating center hole, wherein the top end of the rod consists of a holding block, and the other end consists of a shallow pressing cup, and a preset gap for liquid circulation is formed between the periphery of the pressing cup and the inner wall of the tube; a top cover which is assembled on top of the bracket assembly; and a bottom cover which is assembled on the bottom positioning part of the tube and forms a holding space with the pressing cup in which a brewed substance is placed.

### CROSS REFERENCE TO RELATED APPLICATIONS

The present application claims the benefit of Taiwanese Patent Application No. 110134662 filed on Sep. 16, 2021, the contents of which are incorporated herein by reference in their entirety.

### BACKGROUND OF THE INVENTION

### Field of the Invention

The present invention provides a portable brewing and heat preservation device. Particularly, a filter-pressing sheet arranged in a body is a circular sheet body without any through hole; and a gap between the filter-pressing sheet and the inner wall of the body is used to ensure that brewed substance such as tea is separated from a tea liquor. Furthermore, the filter-pressing sheet can be made of safer and hygienic ceramics, glass or stainless steel coated with a ceramic coating, etc. The circular filter-pressing sheet structure without any through hole does not build up residue easily and is easier to clean. After the tea and the tea liquor are separated, both cannot communicate through holes or filter screens, so the release rate of solutes in the tea is effectively slowed down, preventing tea to get any stronger or bitterer, thus more control of the taste.

### Description of the Prior Art

At present, due to the changes in social patterns, the rapid development of industry and commerce and the compact pace have replaced the relaxing life of the agricultural society in the past. Therefore, in addition to simple drinking, brewing coffee, tea and other beverages have gradually become regulating and leisured elegant taste and social etiquette in daily life. After long-term drinking in moderation, not only the spirit of persons can be improved, but also the effect of health care can be achieved.

Furthermore, at present, utensils and bottles are required to brew beverages such as coffee and tea. For example, when tea is brewed for drinking, the tea needs to be taken out from a tea caddy, put into a teapot and brewed with hot water. when the tea is done steeping, the tea liquor is poured into a tea cup before drinking. However, sometimes, during traveling, meetings or camping, although beverages such as tea or coffee can be purchased from external businesses, many people still want the satisfaction of brewing by themselves anywhere, as well as brewing high-quality beverages by themselves.

However, since many utensils and bottles are required in the brewing process, it is undoubtedly a trouble for people who go out to carry many utensils and bottles. Moreover, the utensils and the bottles will lead to the situation that pots and cups are alternately messy and inconvenient to arranged and use, or even bring inconvenience for storage and cleaning when carrying them out, resulting in many inconveniences for people going out. Therefore, how to solve the inconveniences listed above is the direction that urgently needs to be studied and overcome by relevant people.

### SUMMARY OF THE INVENTION

Therefore, in the view of problems and deficiencies listed above, the inventor collects relevant information, and after multiple evaluations and considerations, the present invention of a portable brewing and heat preservation device is designed.

The main purpose of the present invention is to provide a portable brewing and heat preservation device, comprising: a body with a hollow accommodating space inside, wherein a first positioning part and a second positioning part are arranged on both sides of the body; a push-pull assembly which comprises a bracket positioned at the inner side of the first positioning part of the body, wherein the bracket has a plurality of liquid channels, a push-pull rod stored in the accommodating space is penetrated in the center of the bracket, one end of the push-pull rod is assembled with a holding block, and the other end of the push-pull rod is assembled with a filter-pressing sheet without any through hole, and a preset gap for liquid circulation is formed between the periphery of the filter-pressing sheet and the inner wall surface of the body; a top cover which is penetrated and assembled on the inner wall surface of the first positioning part of the body; and a bottom cover which is penetrated and assembled on the inner wall surface of the second positioning part of the body and is internally provided with a holding space in which a brewed substance is placed. Because the above filter-pressing sheet is a circular sheet body without any through hole, a gap between the filter-pressing sheet and the inner wall of the body is used to ensure that brewed substance such as tea is separated from a tea liquor. Furthermore, the filter-pressing sheet can be made of safer and hygienic ceramics, glass or stainless steel coated with a ceramic coating, etc. The circular filter-pressing sheet structure without any through hole does not build up residue easily and is easier to clean. After the tea and the tea liquor are separated, both cannot communicate through holes or filter screens. Therefore, the release rate of solutes in the tea is effectively slowed down, preventing tea to get any stronger or bitterer, thus more control of the taste. The outer edge of the filter-pressing sheet is further provided with cotton cloth, nylon cloth or silica gel material with small gaps, so as to provide a better effect for filtering the brewed substance such as tea. At the same time, the friction between the filter-pressing sheet and the inner wall surface of the body can be reduced.

Another purpose of the present invention is that the filter-pressing sheet is made of ceramic, glass or stainless steel material coated with a ceramic coating, and the filter-pressing sheet has a disc-shaped structure.

### BRIEF DESCRIPTION OF THE DRAWINGS

FIG. 1 is a three-dimensional external view of a portable brewing and heat preservation device of the present invention.

FIG. 2 is a three-dimensional exploded view of a portable brewing and heat preservation device of the present invention.

FIG. 3 is another three-dimensional exploded view of a portable brewing and heat preservation device of the present invention.

FIG. 4 is a side sectional view of a portable brewing and heat preservation device of the present invention.

FIG. 5 is a first action diagram of a portable brewing and heat preservation device of the present invention.

FIG. 6 is a second action diagram of a portable brewing and heat preservation device of the present invention.

FIG. 7 is a third action diagram of a portable brewing and heat preservation device of the present invention.

FIG. 8 is a fourth action diagram of a portable brewing and heat preservation device of the present invention.

FIG. 9 is a fifth action diagram of a portable brewing and heat preservation device of the present invention.

### DESCRIPTION OF THE PREFERRED EMBODIMENTS

In order to achieve the above purposes and effects, the technical means and structures adopted by the present invention, the features and functions of the present invention are described in detail with reference to the drawings and the preferred embodiments of the present invention so as to fully understand the present invention.

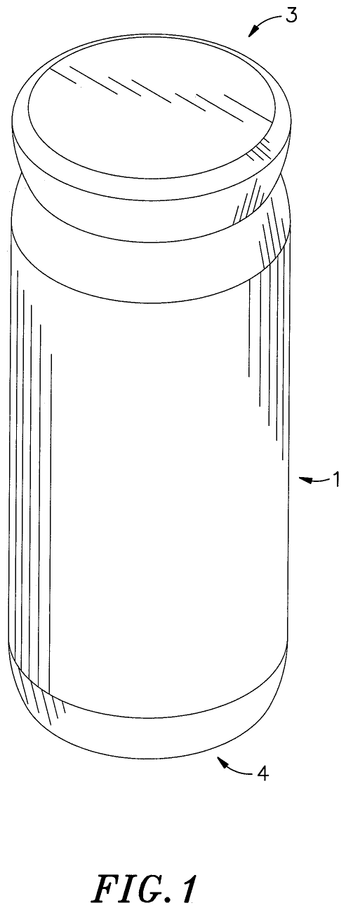

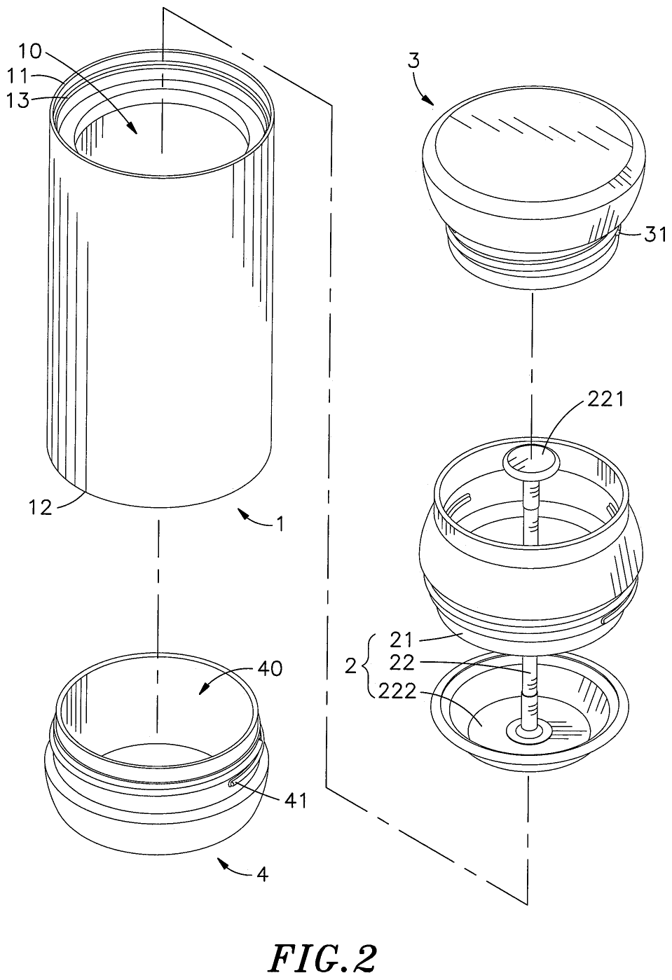

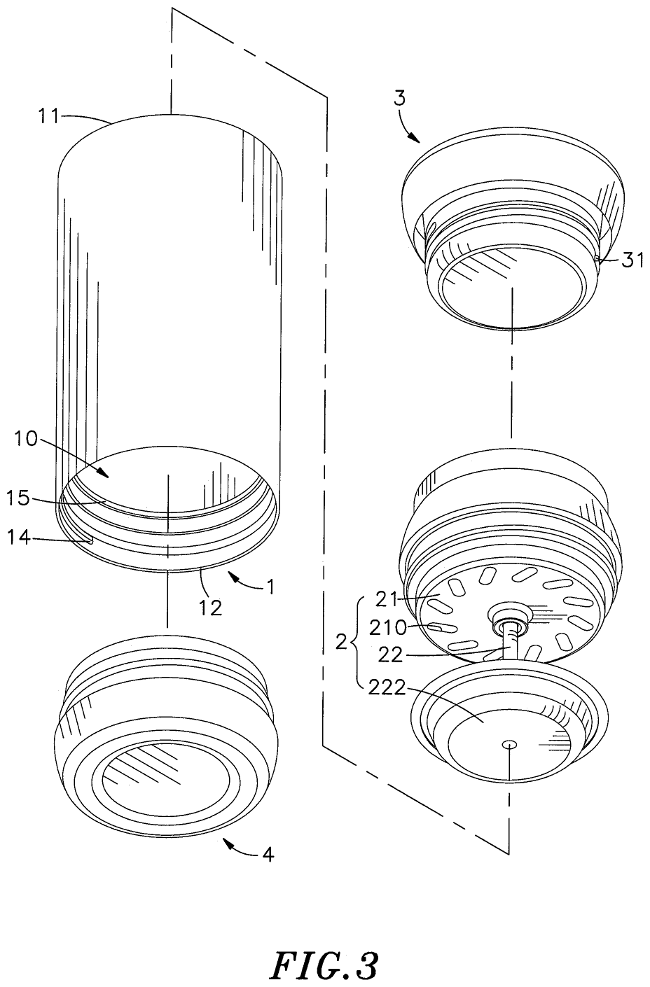

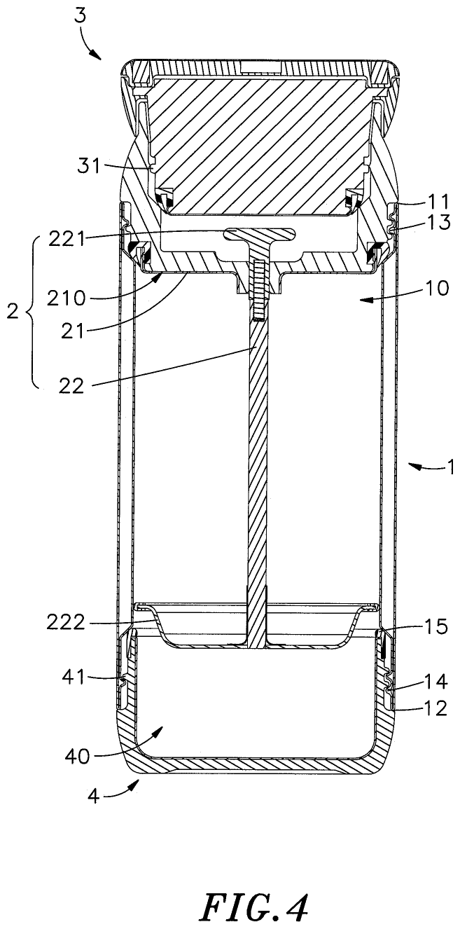

FIGS. 1 to 4 show a three-dimensional external view, a three-dimensional exploded view, another three-dimensional exploded view and a side sectional view of the portable brewing and heat preservation device of the present invention. It can be clearly seen from the drawings that the portable brewing and heat preservation device of the present invention includes: a body 1, a push-pull assembly 2, a top cover 3 and a bottom cover 4, and the detailed structure and connection relationships are as follows:

The body 1 has a hollow accommodating space 10 inside, and a first positioning part 11 and a second positioning part 12 are respectively arranged on both sides of the body 1.

The push-pull assembly 2 includes a cylindrical bracket 21 positioned at the inner side of the first positioning part 11 of the body 1; the bracket 21 has a plurality of liquid channels 210; and a push-pull rod 22 stored in the accommodating space 10 is penetrated in the center of the bracket 21. One end of the push-pull rod 22 is assembled with a holding block 221, and the other end of the push-pull rod 22 is assembled with a filter-pressing sheet 222 without any through hole, and a preset gap for liquid circulation is formed between the periphery of the filter-pressing sheet 222 and the inner wall surface of the body 1.

The top cover 3 is penetrated and assembled on the inner wall surface of the first positioning part 11 of the body 1.

The bottom cover 4 is penetrated and assembled on the inner wall surface of the second positioning part 12 of the body 1 and is internally provided with a holding space 40 in which a brewed substance 5 is placed. The brewed substance 5 refers to tea or ground coffee beans, but the embodiment of the present invention is described with tea, and is not limited to this.

The filter-pressing sheet 222 is made of ceramic, glass or stainless steel material coated with a ceramic coating, and the range of a preset gap between the periphery of the filter-pressing sheet 222 and the inner wall surface of the body 1 is between 0.01 mm and 0.5 mm. The structure of the circular filter-pressing sheet 222 without any through hole does not build up residue easily and is easier to clean. After the tea (the brewed substance 5) and the tea liquor are separated, both cannot communicate through holes or filter screens. Therefore, the release rate of solutes in the tea (the brewed substance 5) is effectively slowed down, preventing tea to get any stronger or bitterer, thus more control of the taste. The outer edge of the filter-pressing sheet 222 is further provided with cotton cloth, nylon cloth or silica gel material with small gaps, so as to provide a better effect for filtering the tea (the brewed substance 5). At the same time, the friction between the filter-pressing sheet 222 and the inner wall surface of the body 1 can be reduced.

A first internal thread 13 and a first external thread 31 that can be screwed mutually are respectively arranged between the first positioning part 11 of the body 1 and the top cover 3, or positioning ribs (not shown in the drawings) that can engage the first positioning part 11 of the body 1 and the top cover 3 are arranged. A second internal thread 14 and a second external thread 41 that can be screwed mutually are respectively arranged between the second positioning part 12 of the body 1 and the bottom cover 4, or positioning ribs (not shown in the drawings) that can engage the second positioning part 12 of the body 1 and the bottom cover 4 are arranged. The above internal thread, external thread and positioning ribs are all common structural designs for assembling two circular bodies, and should be included within the protection scope of the present invention. In addition, the inner wall surface of the second positioning part 12 of the body 1 is further provided with a waterproof gasket 15 sleeved and positioned on the upper edge of the bottom cover 4. The waterproof gasket 15 can prevent the liquid filled in the accommodating space 10 from leaking to the outside from the joint between the body 1 and the bottom cover 4.

To assemble the portable brewing and heat preservation device of the present invention, the push-pull rod 22 of the push-pull assembly 2 and the bracket 21 need to be assembled at first, so that the push-pull rod 22 penetrates through the center of the bracket 21 and then the push-pull assembly 2 is fixed to the inner side of the first positioning part 11 of the body 1. At this time, the filter-pressing sheet 222 on the bottom side of the push-pull rod 22 is accommodated in the accommodating space 10, and the holding block 221 on the top side of the push-pull rod 22 protrudes from the outside of the body 1. Then, the bottom cover 4 is fixed at the second positioning part 12 of the body 1 in a screwing or clamping manner. The top cover 3 is also fixed at the first positioning part 11 of the body 1 in a screwing or clamping manner, so as to complete the assembly of the portable brewing and heat preservation device of the present invention.

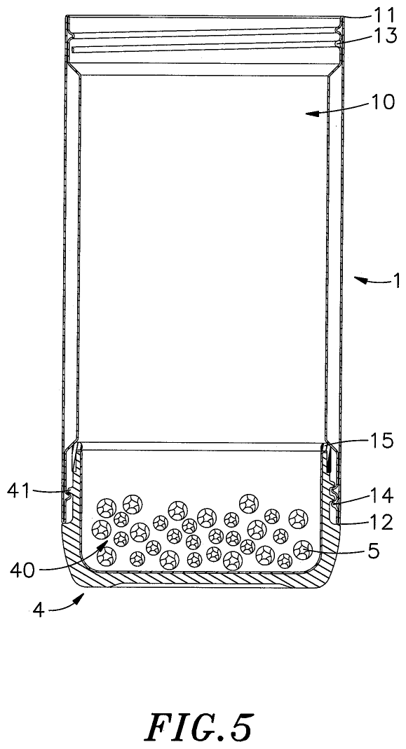

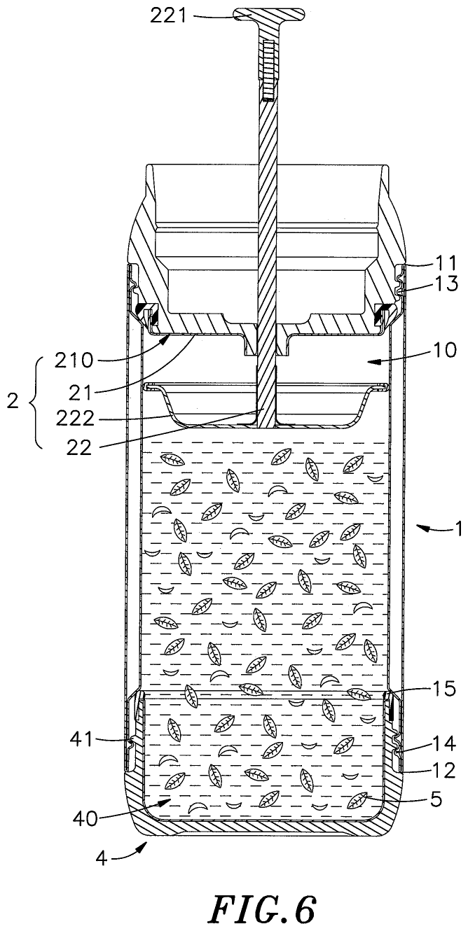

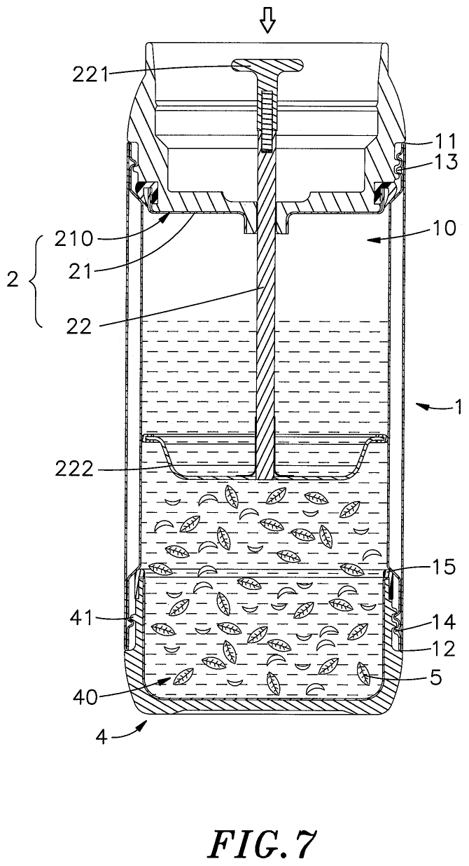

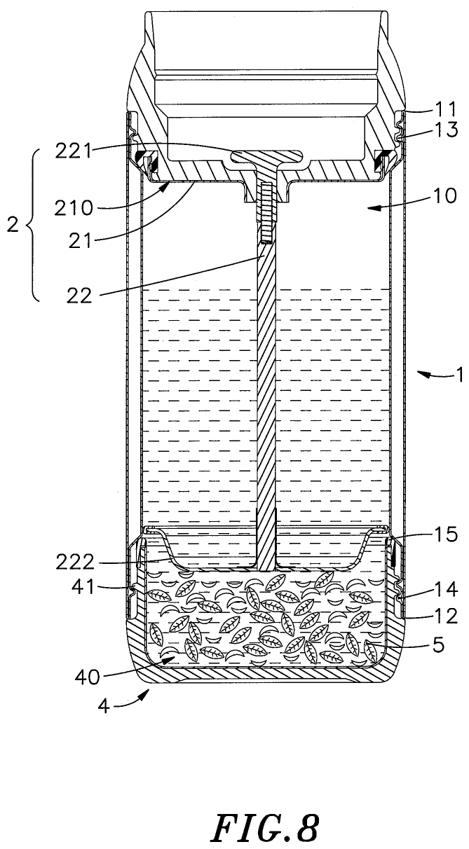

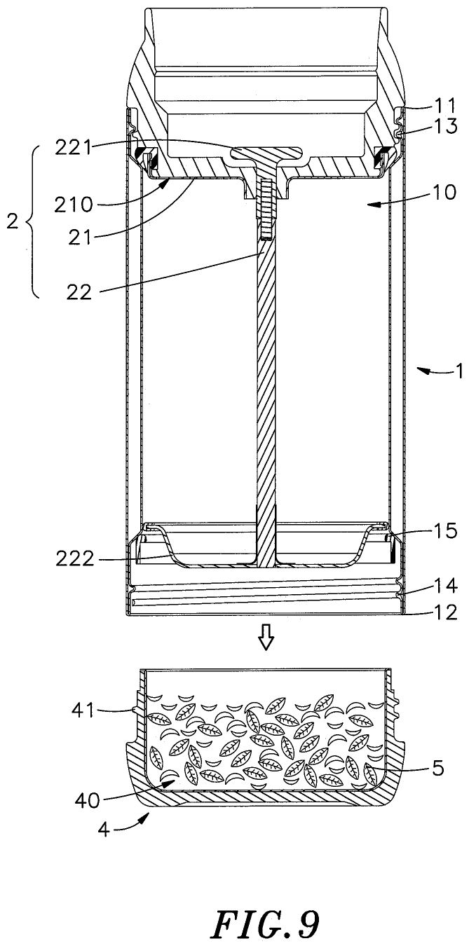

FIGS. 5-9 show all action diagrams of the operation of the portable brewing and heat preservation device of the present invention. In the actual operation of the portable brewing and heat preservation device of the present invention, after the top cover 3 is opened at first, the push-pull assembly 2 should be taken out from the body 1; the brewed substance such as the tea is put into the holding space 40 of the bottom cover 4 from the first positioning part 11 of the body 1; and then preset hot water or cold water is poured into the holding space 40. At this time, the brewed substance 5 will stretch out in the accommodating space 10 and the holding space 40, and components are released to form a tea liquor. After a preset time is reached, the push-pull assembly 2 is screwed on the inner side of the first positioning part 11, and a force is applied to the holding block 221 on the top side of the push-pull rod 22 downward so that the filter-pressing sheet 222 on the bottom side can press down the stretched tea (the brewed substance 5) into the holding space 40 of the bottom cover 4. During the pressing process, the tea liquor continuously flows upward from the preset gap between the periphery of the filter-pressing sheet 222 and the inner wall surface of the body 1 to enter the accommodating space 10 above the filter-pressing sheet 222. After the tea (the brewed substance 5) is separated from the tea liquor, the user can drink the tea liquor. After several times of brewing, the flavor of the brewed substance 5 has become weak. At this time, it is necessary to clean the brewed substance 5. The specific practice is to remove the bottom cover 4 at first, so that most of the brewed substance 5 is removed along with the bottom cover 4. At this time, the push-pull rod 22 is pressed down again to push all the remaining brewed substance 5 out of the body 1, and then the brewing and heat preservation device can be cleaned. Through the above operation, a device with simple operation, convenient carrying and moderate tea taste can be achieved.

As shown in FIG. 1-FIG. 9, it can be understood that the present invention is a portable brewing and heat preservation device, comprising: a body with a hollow accommodating space inside, wherein a first positioning part and a second positioning part are arranged on both sides of the body; a push-pull assembly which comprises a bracket positioned at the inner side of the first positioning part of the body, wherein the bracket has a plurality of liquid channels, a push-pull rod stored in the accommodating space is penetrated in the center of the bracket, one end of the push-pull rod is assembled with a holding block, and the other end of the push-pull rod is assembled with a filter-pressing sheet without any through hole, and a preset gap for liquid circulation is formed between the periphery of the filter-pressing sheet and the inner wall surface of the body; a top cover which is penetrated and assembled on the inner wall surface of the first positioning part of the body and which has a holding space for holding the push-pull rod of the push-pull assembly and holding the liquid; and a bottom cover which is penetrated and assembled on the inner wall surface of the second positioning part of the body and is internally provided with a holding space in which a brewed substance is placed. Because the above filter-pressing sheet is a circular sheet body without any through hole, a gap between the filter-pressing sheet and the inner wall of the body is used to ensure that brewed substance such as tea is separated from a tea liquor. Furthermore, the filter-pressing sheet can be made of safer safe and hygienic ceramics, glass or stainless steel coated with a ceramic coating, etc. The circular filter-pressing sheet structure without any through hole does not build up residue easily and is easier to clean. After the tea and the tea liquor are separated, both cannot communicate through holes or filter screens. Therefore, the release rate of solutes in the tea is effectively slowed down, preventing tea to get any stronger or bitterer, thus more control of the taste. The outer edge of the filter-pressing sheet is further provided with cotton cloth, nylon cloth or silica gel material with small gaps, so as to provide a better effect for filtering the brewed substance such as tea. At the same time, the friction between the filter-pressing sheet and the inner wall surface of the body can be reduced. The present invention is applied to a heat preservation device with a brewing function and has excellent efficacy. Therefore, a patent application is filed to seek protection of the patent right.

The above is only a preferred embodiment of the present invention, and does not limit the patent scope of the present invention. Therefore, any simple modifications and equivalent structural changes made by using the contents of the description and drawings of the present invention should be similarly included in the patent scope of the present invention and explained hereby.

To sum up, the above portable brewing and heat preservation device of the present invention can achieve the effects and purposes when used. Therefore, the present invention is an invention with excellent practicability. In order to conform to the application requirements for the patent for invention, the application is filed in accordance with the law, with a hope that the review committee will approve the case as soon as possible to protect the invention of the inventor. If the review committee of the bureau has any questions, please do not hesitate to inform us, and the inventor will do his best to cooperate, with sincere request.

### DESCRIPTION OF SYMBOLS

1: Body
10: Accommodating space
11: First positioning part
12: Second positioning part
13: First internal thread
14: Second internal thread
15: Waterproof gasket
2: Push-pull assembly
21: Bracket
210: Liquid channel
22: Push-pull rod
221: Holding block
222: Filter-pressing sheet
3: Top cover
31: First external thread
4: Bottom cover
40: Holding space
41: Second external thread
5: Brewed substance

What is claimed is:

1. A portable brewing and heat preservation device, comprising:
a body with a hollow accommodating space inside, wherein a first positioning part and a second positioning part are arranged on both sides of the body;
a push-pull assembly which comprises a bracket positioned at the inner side of the first positioning part of the body, wherein the bracket has a plurality of liquid channels, a push-pull rod stored in the accommodating space is penetrated in the center of the bracket, one end of the push-pull rod is assembled with a holding block, and the other end of the push-pull rod is assembled with a filter-pressing sheet without any through hole, and a preset gap for liquid circulation is formed between the periphery of the filter-pressing sheet and the inner wall surface of the body;
a top cover which is penetrated and assembled on the inner wall surface of the first positioning part of the body; and
a bottom cover which is penetrated and assembled on the inner wall surface of the second positioning part of the body and is internally provided with a holding space in which a brewed substance is placed.

2. The portable brewing and heat preservation device of claim 1, wherein a default gap range is between 0.01 mm and 0.5 mm.

3. The portable brewing and heat preservation device of claim 1, wherein the filter-pressing sheet is made of ceramic, glass or stainless steel material coated with a ceramic coating, and the filter-pressing sheet has a disc-shaped structure; and the outer edge of the filter-pressing sheet is further provided with cotton cloth, nylon cloth or silica gel material with small gaps, so as to provide a better effect for filtering the brewed substance.

4. The portable brewing and heat preservation device of claim 1, wherein the inner wall surface of the second positioning part of the body is further provided with a waterproof gasket sleeved and positioned on the upper edge of the bottom cover.

5. The portable brewing and heat preservation device of claim 1, wherein the brewed substance refers to tea or ground coffee beans.

6. The portable brewing and heat preservation device of claim 1, wherein a first internal thread and a first external thread that can be screwed mutually are respectively arranged between the first positioning part of the body and the top cover.

7. The portable brewing and heat preservation device of claim 1, wherein a second internal thread and a second external thread that can be screwed mutually are respectively arranged between the second positioning part of the body and the bottom cover.
